(19) United States
(12) Patent Application Publication
(10) Pub. No.: US 2009/0204429 A1
(43) Pub. Date: Aug. 13, 2009

(54) OCCUPATIONAL HEALTH DATA SYSTEM AND METHOD

(76) Inventor: Simon Barker, Surrey (GB)

Correspondence Address: Peter L. Berger, Esq.;Levisohn, Lerner, Berger & Langsam, LLP, Suite 2500, 757 Third Avenue, New York, NY, 10017, US

(21) Appl. No.: 12/424,672

(22) Filed: Apr. 16, 2009

Related U.S. Application Data
(62) Division of application No. 10/636,389, filed on Aug. 6, 2003.

(51) Int. Cl. G06Q 50/00

(52) U.S. Cl. 705/2

(57) ABSTRACT

A method and system for employee life cycle management collects occupational health data from a plurality of diverse occupational health data sources for a plurality of employees, stores the collected data in a central database, processes the data to generate employee life cycle data, stores the employee life cycle management data in the database, and centrally manages the employee life cycle management data to make the employee life cycle data available to at least one employer.

### CROSS-REFERENCE TO RELATED APPLICATIONS

This application is a divisional of and claims priority to U.S. patent application Ser. No. 10/636,389, filed Aug. 6, 2003, which application is hereby incorporated by reference to the extent permitted by law.

### BACKGROUND OF THE INVENTION

Occupational Health is health screening and/or healthcare monitoring performed on prospective and current employees. There is increasing pressure on companies to ensure that their prospective and current employees are fit to do the work they are employed for. In order to avoid accidents, injuries and possible compensation claims, employers are required to monitor the health of their employees throughout their terms of employment.

Employers therefore need to be able to access occupational health information throughout the career of an employee so that they can assess the suitability of the employee to carry out specific tasks. The employer also needs to monitor that any occupational hazards present are not having an effect on the employee's health, thus leading to possible illness and claims for damages being made against the employer.

In addition to company occupational health standards, an employer must comply with Federal, State and Local Government regulations on standards of occupational health and safety in the workplace and the Occupational Safety and Health Administration (OSHA) in the USA. For example, OSHA has strict medical clearance programs for industry, to ensure that workers have the prescribed standard of respiratory protection if working in an atmosphere containing substances harmful if inhaled, that the hearing of workers using noisy machinery is not affected, and also that workers are not exposed to hazardous chemicals and toxic substances such as heavy metals and asbestos.

The cost of employers' insurance is rising as more workers seek compensation for work-related illness and injury, as is the cost of risk assessment and claims management. Litigation for work-related illnesses is spiralling, leading to companies losing money in compensation costs, as well as negative exposure. There is thus a need for a means by which employers can reduce and manage the risks posed by the employers liability for the health and safety of their employees.

At present, the total estimated cost of complying with OSHA regulations is 34 billion dollars and the total cost of workers' compensation is estimated to be 130 billion dollars, which illustrates the importance of occupational health issues. Given that workforce demographics and the international logistics of companies are constantly changing, it is becoming more important to continuously update occupational health data and store the data where it can be accessed quickly and easily.

A problem with existing systems for managing occupational health data is that they are very fragmented. That is, there are many individual suppliers or vendors for individual health screening, testing, consultation, etc and there is no coordination of their data provision. For example, a company must go to one supplier to collect a sample for a substance abuse test and a different supplier to perform the laboratory test, then collate the data from the many different suppliers themselves or use a separate occupational health consultant. This is a very inefficient and costly way of managing occupational health data, especially when there may be many different physical or biological tests that need to be performed on employees during their careers, as well as safety tests and training on equipment.

### SUMMARY OF THE INVENTION

FIG. 1 illustrates the usual method of occupational health process flow. Data is gathered separately by different providers and sent to the client, who then collates the data from the different sources, such as clinics, laboratories, occupational health consultants etc. They must then spend time recording the separate data and processing it into a meaningful form. As shown in FIG. 1, the sources or providers from which the data is collected are completely separate and there is no communication between them. There is no provision for one occupational health provider to access information from another provider, or for the client to continuously access data over a network from any of the occupational health providers and for providers to exchange data. Also, the data cannot be recorded, stored, processed and accessed from one place in the usual process flow, thus leading to a very inefficient way of managing occupational health data. This becomes particularly important if the client is a company having several branches, possibly in different countries. The current system therefore separates the components of the employee life cycle so there is no way of efficiently managing employee life cycle data.

Another problem with the current system is that there exists no secure management of tests and data. For example, at present, if an audiometric test is performed on one person, it is possible for the wrong person to be tested accidentally or deliberately in order to avoid being prevented from working such as where the employer stipulates a certain capability to perform the job. The data itself is very fragmented and stored in many different places so it is very difficult to have easy access or apply standardization to all the occupational health data for one employee during their working lifetime, let alone the large number of workers employed by a multinational company. Companies are therefore unable to consolidate occupational health data from their employees into valuable management information using currently available services.

It is an object of the present invention to provide an occupational health data system that provides centralised occupational health employee life cycle management.

A first aspect of the present invention provides a computer system and method for facilitating employee occupational health management. A database stores employee occupational health data for a plurality of employees and for a plurality of employers. One or more database interfaces are provided to allow the employee occupational health data to be input from a plurality of diverse employee occupational health data sources providing diverse occupational health data for employees. One or more employer interfaces allow employers to access the employee occupational health data in the database.

Thus this aspect of the present invention provides for consolidation of occupational health data from a plurality of diverse sources providing diverse types of occupational health data. The central collocation of the data also facilitates the bringing together of occupational health data for not just a number of employees, but also for employees of different employers. This allows anyone of a number of employers to access consolidated occupational health data for any of their employees. In one embodiment of this aspect of the present invention the database stores employee life cycle data for the employees. The processing arrangement within the computer system, which can comprise a single processor or a collection of processors, processes the received occupational health data to generate the employee life cycle data. Thus the employee life cycle data comprises processed raw occupational health data. The processing can provide the occupational health data in a more user friendly form and can incorporate parameters from other data sources to provide a more complete employee life cycle picture which need not be restricted to occupational health data parameters for the employee. For example, personal data can be stored for the employee and this can be processed with the occupational health data to generate the employee life cycle data.

In one embodiment of the present invention the employee life cycle data comprises data gathered over more than one employment cycle. Thus the system can store a complete employee employment history with respect to parameters related to occupational health and safety in particular. The database can thus store occupational health data for previous as well as current employment periods. This enables employers to use the system to access occupational health-related data for prospective as well as current employees. Employers are able to use the system for prospective employers in order to look at their occupational health and safety history for previous employments. The system can of course also be used for tracking and maintaining occupational health and safety data for current employees.

The provision of employment history data in the system together with the consolidation of occupational health data from a multitude of diverse sources enables the provision of a comprehensive employee life cycle management system formed by a network between a multitude of occupational health suppliers and their clients, i.e. the employers. The system provides for the collection, storage, processing and management of employee life cycle data including possibly occupational health data and possibly occupational health and safety data for employees of any employers utilizing the system.

Although the system of this aspect of the present invention provides principally for the central collection of data digitally to facilitate management and provision of data with mediacy, all of the occupational health data input into the system need not be received centrally in a digital form. For example, occupational health data could be sent as paper, e.g. completed health questionnaires from employees and the data on these forms can be entered into the system. Thus the system can provide for the collection, processing, management and provision of employee life cycle management data. The employee life cycle data comprises data related to occupational health issues related to recruitment, training, job ability, injury, re-employment and retirement. Thus the employee life cycle data is relevant for the process of pre-employment carried out by employers, employment compliance, safety training, wellness programmes, injury reporting, compensation claims management, and return to work programmes.

The occupational health data comprises any health parameters related to the future, current and previous occupations of an employee. The occupational health parameters relate to the ability of the employee to do the job, the impact of the employment on their health, and the need for regulatory compliance i.e. national, federal, state or local authority regulations, and corporate regulations. The occupational health data can be indicative of either or both of the physical and mental state of the employee.

In one embodiment of the present invention each employee record comprising occupational health data stored in the database is identified by a unique identification number or code. This facilitates the identification of the employee individually and separably from the employer. This therefore facilitates the retrieval of employee life cycle data for an employee independently of the employer. In other words, when an employee has been employed by a number of employers subscribing to the system, an employment history will be built up for the employee together with an occupational health data history.

The employee life cycle data can include occupational health and safety data, employee personal data, employee employment history data (e.g. identification of previous employers and employment periods), medical data, e.g. data on any medical conditions which may impinge on an employee's ability to carry out their duties, employment compliance data, e.g. audiometric testing data for employees subject to a noisy working environment, safety training data, e.g. information on the training an employee has received relevant to their duties, wellness programme data, e.g. information on preventative measures being taken by employees in order to avoid medical problems such as attendance at a gym, injury report data, insurance or compensation claim data, occupational equipment safety test data related to employees, e.g. safety tests carried out on equipment utilized by employees so that correlations between any injuries or events associated with the equipment and the employee can be identified, training data for the employee, e.g. information on the training courses and the training standards attained by the employee, and near miss and accident data.

It can thus be seen that the employee life cycle data can provide a wealth of information for an employee on parameters related to and affecting their health.

In one embodiment of the present invention at least one database input interface is provided to allow health and/or safety test data obtained from one or more health and/or safety tests performed on or by the employee to be entered into the database. Thus in this embodiment of the present invention the occupational health data includes test data indicative of a physical or mental function of the employee. Such tests can, for example, be audiometric tests to test for the audiometric capability of an employee, an eyesight test, a blood test, a urine test, a psychometric test, or a DNA test.

For certain such tests it is necessary for a medical practitioner or laboratory technician to review the test results in order to provide for analysis of the test results. Therefore the system provides for a means of interfacing an examiner or reviewer of the tests to enable the examiner or reviewer to review the test data and to input analysis data into the database. For example, for a blood or urine test it may be a condition of regulatory compliance that the level of a particular substance found in the sample of an employee be below a threshold. Thus the examiner or reviewer can apply such regulatory parameters to the test results and input analysis data such as an indication of whether the result is in regulatory compliance or not. In addition, other comments can be added to enhance the level of occupational health data populating the database for an employee.

In this embodiment of the present invention, the database can store data on the reviewer or examiner and data on the examination or review process and equipment. Thus for a blood test, for example, the data can identify the blood test result reviewer, their qualifications etc., and information on the review process carried out and any equipment used for the review process. In addition, the test data can not only give the test results, but also can indicate where the test was carried out and by whom, and what facility was used to carry out the test, e.g. what machine.

In one embodiment of the present invention, the system is provided with an interface to an insurance computing system. This allows an insurer to access the database to access the occupational health data for the employees for which they have insurance liability. In this embodiment the insurer is thus integrated within the employee life cycle management system. The employee can enter health and/or safety requirement parameters into the database which are required to be adhered to by employers in order to validate their insurance with the insurer. Employers can thus access this information directly through the system, thereby to provide a central point of access for all information related to health and safety of their employees.

In one embodiment of the present invention a system includes an interface to a regulatory body in order to generate regulatory compliance reports for the regulatory body as required. The system can thus be programmed to generate compliance reports as necessary for employers in order to meet their regulatory requirements. Thus the centralization of the data for a plurality of employers and employees and the interfacing of it to be regulatory body provides for a life cycle management system which enables employers not only to manage their employees, but also to meet their regulatory requirements more easily.

In the present invention the occupational health data is not restricted to text data and can comprise image data, video data, or audio data, or a combination of any of these. Thus for example test data can be stored in the form of graphs, or where there has been an accident, photographs of the incident or equipment responsible can be entered into the database. Also where there has been an accident, or a regulatory breach, witness statements can be kept either as audio data or video data rather than requiring the transcription of these into text form.

In addition to allowing employers to access the employee life cycle data in the database, the system can allow limited access to employees to allow them to inspect data stored on the computer for them. This facility can for example enable the meeting of data protection regulatory requirements by allowing employee access to determine what data is held in the system for them.

The system of one embodiment of the present invention also enables employers or other users of the system to have reports generated for them. The reports can be tailored to suit their requirements.

A second aspect of the present invention provides an employee life cycle management system and method in which employee occupational health data is collected from a plurality of diverse occupational health data sources for a plurality of employees. The collected data is stored in a central database. The data is then processed to generate employee life cycle data and this data is stored in the database. The employee life cycle management data is centrally managed to make the employee life cycle management data available to at least one employer.

Another aspect of the present invention provides a secure occupational health management system and method in which employee related data is stored in a database together with associated unique biometric identifier data for the employee. Occupational health data is collected from the employee accompanied with measured biometric identifier data obtained from the employee during the collection of the occupational health data from the employee. The measured biometric identifier data is compared with the unique biometric identifier data stored in the database and if the comparison indicates a match, the collected occupational health data from the employee is stored in the database.

Thus in accordance with this aspect of the present invention, the use of a biometric identifier during the collection of occupational health data from an employee enhances the accuracy and security of the occupational health management system. Currently it is possible for employees to defraud the system by getting a friend to stand in for them during a health test. In accordance with this aspect of the present invention, this is prevented by requiring the measuring of a biometric parameter from the employee giving the occupational health data, i.e. undergoing the test. This ensures that the occupational health data does in fact come from the employee. For example, when a test is done such as an audiometric test, an eyesight test, blood test, a urine test, a physical examination, or a psychometric test, at the time of carrying out the test, a biometric measurement can be made such as a hand shape, fingerprint, retinal scan, or DNA.

In accordance with one embodiment of the present invention, the occupational health data is collected from an employee using a mobile occupational health data collection facility. Such a facility is common in remote or in hostile environments where mobile units travel to employer premises in order to carry out occupational health tests. It is often the case, therefore, that the testers do not know the employees and thus it is important in order to ensure the validity of the system that a biometric measurement is used in order to validate the test result for an employee.

In this aspect of the present invention, often the occupational health data collected from the employee requires examination or review. Thus in one embodiment of the present invention an interface is provided for enabling one or more reviewers or examiners to review or examine the occupational health data collected in order to generate and input review data. The reviewers and examiners can comprise medical practitioners or laboratory technicians skilled in the examination or analysis of the occupational health data. They can thus provide expert opinions on the information and this opinion data or analysis data can be entered into the database to supplement a raw test data.

The aspects of the present invention can be implemented on a computer system networked to sources of occupational health data. A computer system can comprise one or any number of computers or processors operating in a coordinated manner in order to collect, collate, process, store, manage and make available occupational health related data. The networking of the computer system to occupational health data sources can be carried out using any convenient communication network. A current prevalent network is the Internet enabling public access over the worldwide web restricted as required using passwords to control access to the system. The present invention is however not limited to such an implementation and any communication system and communication protocol can be used.

Since the present invention can be implemented in a computer system, the present invention encompasses computer code for execution by a computer system in order to implement the system in accordance with the present invention. The computer code in accordance with one embodiment of the present invention can be provided on any suitable carrier medium such as a transient medium, i.e. a signal such as an electrical signal, a microwave signal, an optical signal, an acoustic signal, an electromagnetic signal, a microwave signal, or an rf signal. Alternatively, the carrier medium can comprise a storage medium such as a floppy disk, hard disk, optical disk, e.g. CD-ROM, or a programmable solid state memory device.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

Embodiments of the present invention will now be described with reference to the accompanying drawings, in which:

FIG. 1 is a schematic diagram of existing systems for managing occupational health and employee life cycle data;

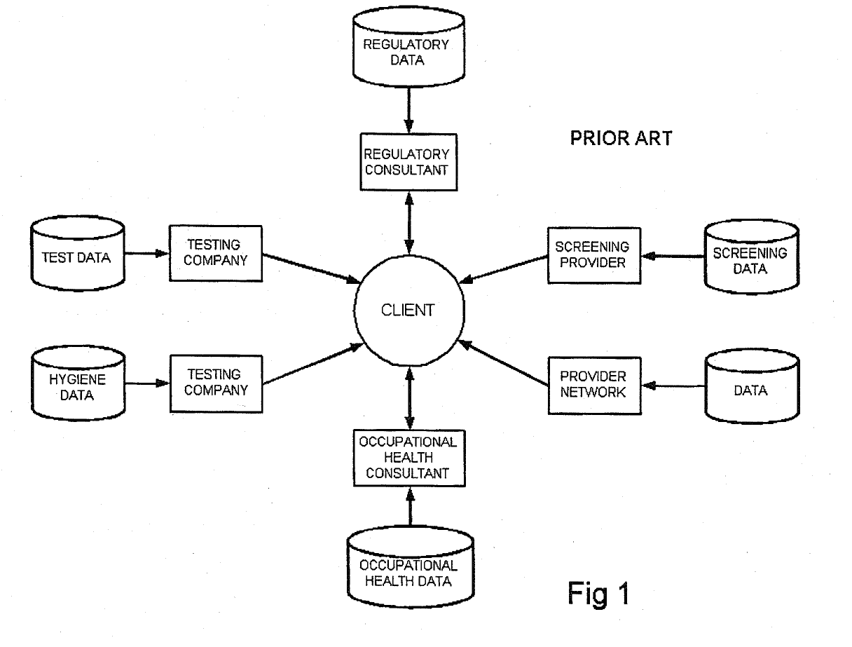

FIG. 2 is a schematic diagram of an employee life cycle management computer system in accordance with an embodiment of the present invention;

FIG. 3 is a schematic diagram of the input of the employee related parameters to the database;

FIG. 4 is a schematic diagram of the concept of employee life cycle management; and

FIG. 5 is a schematic diagram of the employment stages during which employers can use the employee life cycle data.

### DETAILED DESCRIPTION OF THE INVENTION

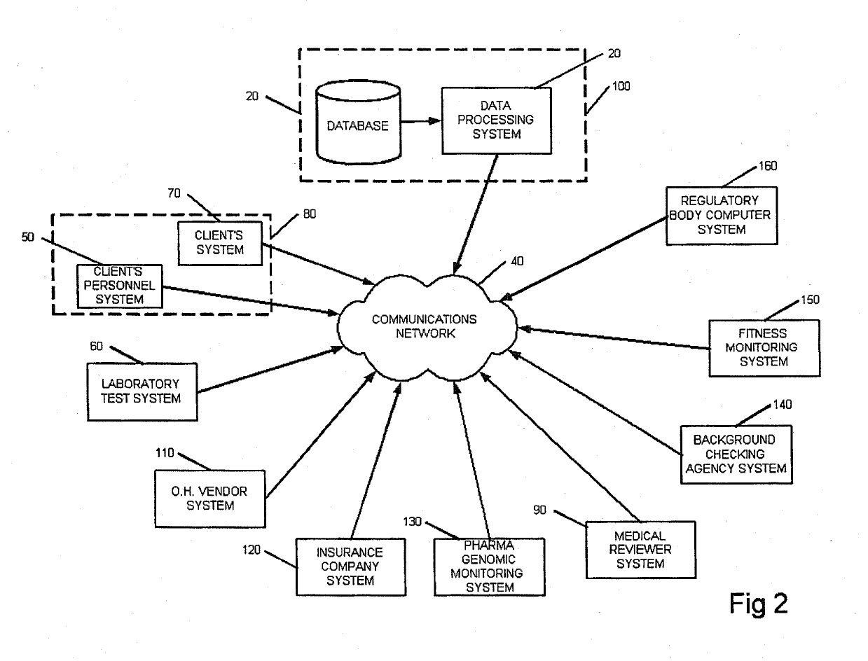

FIG. 2 illustrates schematically an employee life cycle management computer system in accordance with an embodiment of the present invention. In this embodiment a data processing system 20 which can comprise a single computer system or a number of computers linked together is connected to a database 30 for storing employee life cycle data. The data processing system 20 is connected to a communications network 40 which can conveniently comprise the Internet. The data processing system 20 can thus provide web page interfaces to enable the entry and retrieval of data in the database 30. Thus the data processing system 20 and the database 30 are at the heart of the employee life cycle management system and efficient management is provided by the networking of the data processing system 20 to a diverse number of employee life cycle data sources and to other users or parties concerned with the management of the employee life cycle data or interested in accessing the employee life cycle data.

In this embodiment a personnel system 50 is connected to the communications network 40 to enable employee personnel record data to be transferred to the data processing system 20 for entry into the database 30. At a client's, e.g. an employer's premises 80, the client has a system 70 connected to the communications network 40 for accessing the database 30 via the data processing system 20. Typically clients of the life cycle management system comprise employers seeking to obtain managed employee life cycle data. Employers can thus comprise a source of occupational health data for employees where they obtain such data from their employees. This can be input into the database 30 for central management together with occupational health data from other sources.

A laboratory test system 60 is provided for communicating laboratory test results over the communications network 40 to a database 30 via the data processing system 20. Since such data can be raw data, e.g. blood test results or audiometric tests, a medical reviewer system 90 is provided connected to the communications network 40 to enable a medical reviewer to access raw test data in the database 30 via the data processing system 20 in order to review the data and potentially input data analysis results into the database 30.

An occupational health vendor system 110 is also connected to the communications network 40 in order to input occupational health data parameters for employees into the database 30. The occupational health vendor can comprise a known prior art occupational health data provider.

An insurance company system 120 is also connected to the employee life cycle management system 100 via the communications network 40. This enables the insurance company to contribute to and benefit from the managed employee life cycle data during the provision of insurance cover to an employee.

A pharma genomic monitoring system 130 is provided for inputting pharmacological and genomic data related to employees. The pharma genomic monitoring system 130 is connected to the communications network 40 for the input of the data into the database 30 via the data processing system 20.

A background checking agency system 140 is provided for the input of background checking parameters such as criminal records into the database 30 via the communications network 40 and the data processing system 20.

A fitness monitoring system 150 enables the input of fitness parameters into the database 30 via the communications network 40 and the data processing system 20.

A regulatory body computer system 160 is connected to the communications network 40 for allowing the data processing system 20 in the employee life cycle management system 100 to retrieve regulatory parameters and to generate regulatory compliance reports and data to facilitate the regulatory compliance of the employer clients.

It can thus be seen from FIG. 2 that the embodiment of the present invention comprises a networked computer system in which the employee life cycle management system 100 is networked to a plurality of diverse occupational health sources as well as other employee related data sources to enable the collection, processing, management, and provision of employee life cycle data with a high degree of immediacy.

The employee life cycle data in the database 30 will now be described.

The database stores data pertaining to the generic health and occupational health of employees. Each employee is assigned a unique identification number or code and the employee's data is initially set up with personal data including name, address, age, sex, height, weight, marital status, job description, job status, employment history (including links to any employer's identification codes for employers that are clients of the employee life cycle management system), etc. This data can be obtained from the employer's personnel system 50. The employee data can also include biometric identifier data such as finger prints, an iris scan, hand shape or even DNA to enable the unique identification of an employee, particularly when they are submitting occupational health test data as will be described in more detail hereinafter. Input data used to populate an employee record include: a) employee entered data e.g. questionnaire/form filling b) medical history c) occupational health test data e.g. physical (e.g. audiometric test results, eye test results, and spirometric), medical (medical test results), and chemical (e.g. blood test and urine test) d) training record (This indicates if an employee has received sufficient training to safely carry out their duties i.e. have they been trained to a level sufficient to enable them to carry out their job and have they been trained in safety aspects of the job) e) general information. This can include life style data and wellness program data for example. The wellness program data can include fitness program information or an obesity program for example with the aim of preventing work related health issues as a result of the life style of the employee. This can also identify a union to which the employee belongs. f) injury history. This can include pertains of past and present work related injuries that have occurred to the employee. g) return to work information. This can include information on the status of the employee's return to work program following an injury. It can for example indicate if the employee is likely to be able to return to the same job or not and if not, it can indicate the category of job that the employee is likely to be able to return to, the time scale involved i.e. the time taken off work and the further time likely before the employee can return to work, and any medical check up program required.

The database also stores regulatory compliance data which can be input from the regulatory body computer system 160. This data comprises industry standard regulatory compliance data that must be applied to all employers in an industry. The regulatory compliance data can for example comprise test comparison parameters such as audiometric base lines, acceptable drug levels, and spirometry levels.

The database also stores employer or client data. Each employer is assigned a unique identifier code. The employer data includes: a) company information such as name, and addresses b) list of employees identified by their unique identification codes c) relevant regulatory bodies d) field of business e) size of business f) unions to which the employees belong g) corporate compliance regulations h) details of insurer including their unique identifier code i) report types and regularity (optional)

The database also stores data on the testers performing the employee tests to provide the raw test data e.g. blood test results, urine test results, eye test results, audiometric test results and psychometric test results. This data includes: a) personal details of the tester b) qualifications of the tester c) details of the test equipment used by the tester, including model type, last calibration date, age and serial number

The test data stored in the database for each employee includes: a) the employee b) laboratory location or facility used for the test c) the tester who performed the test d) the equipment used for the test e) the examiner or reviewer to be used to examine or review the test data f) the test result g) cost to perform the test h) date and time of the test i) when the test sample was sent to the laboratory and when the test result was received from the laboratory. This keeps a record of efficiency at the test facility to identify where there may be delays in handling of employee samples. It also provides an audit trail which can be important in disputed cases. j) when the test result was reviewed by the employer (client) k) examination result or review analysis for the test data

The database also includes data on the laboratory: a) name and location b) qualifications and accreditations to perform the tests c) equipment available for the tests d) test history e) testers at the laboratory f) cost of performing tests

The database also includes data on the examiner or reviewer: a) personal details of the examiner or reviewer b) qualifications and accreditations of the examiner or reviewer c) location of the examiner or reviewer d) the employer of the examiner or reviewer e) cost of the examination or review f) date and time of the review g) examination or review history

The database also includes data on the clinics, mobile units or collectors used for collecting samples from employees: a) name and location b) qualifications and accreditations for collection c) testers to be used or available to test samples taken d) collection history

The database further includes insurer data: a) name and contact details b) policy details c) employers insured d) notification requirements. This indicates the conditions of insurance policies for employers to notify occupational health and safety information to the insurer. e) testing requirements for employees. This indicates the employee testing requirements imposed by the insurer on the employer for their employees under the terms of the insurance policy.

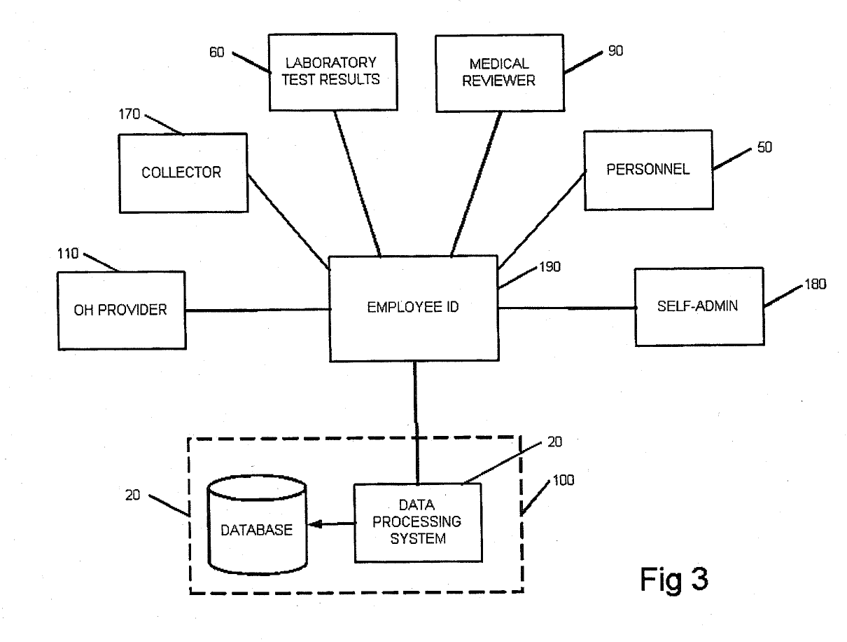

FIG. 3 is a schematic diagram illustrating the input of data into the database for employee related parameters. The employee life cycle management system 100 comprises the database 30 and the processing system 20 as described with reference to FIG. 2. Employee related parameters that are input to the database 30 are assigned en employee ID 190 by the processing system 20. Thus, the employee ID 190 indexes all employee data. Employee related parameters as described hereinabove is thus input from the occupational health provider 110. Such a provider can comprise a clinic where data is collected and possibly processed i.e. the clinic has laboratory facilities. The provider can also comprise a mobile facility for input of occupational health data e.g. an audiometric facility that travels to employer's facilities to perform audiometric tests on employees. The occupational health data can also come from the employers as self-administration occupational health data. A data collector 170 collects raw data that may or may not require processing e.g. a person tasked with collecting occupational health data by getting employees to fill in questionnaires. Laboratory tests results 60 for employee tests are also input to the database 30. A medical reviewer or examiner 90 will access and examine or review the test results e.g. blood test results, urine test results or audiometric test results to analyse the results and determine if they comply with regulatory or corporate regulations. The analysis results for test are input to the database 30 for employee identifying the employee by their employee ID 190. Personnel information 50 is also input to the database 30 for each employee. Employers can perform self administration 180 of certain occupational health data for employees and this data, collected and possibly processed by the employers, is input to the database.

The present invention can facilitate occupational health related programs. The implementation of the employee life cycle management system in the management of an employment life cycle of an employee will now be described.

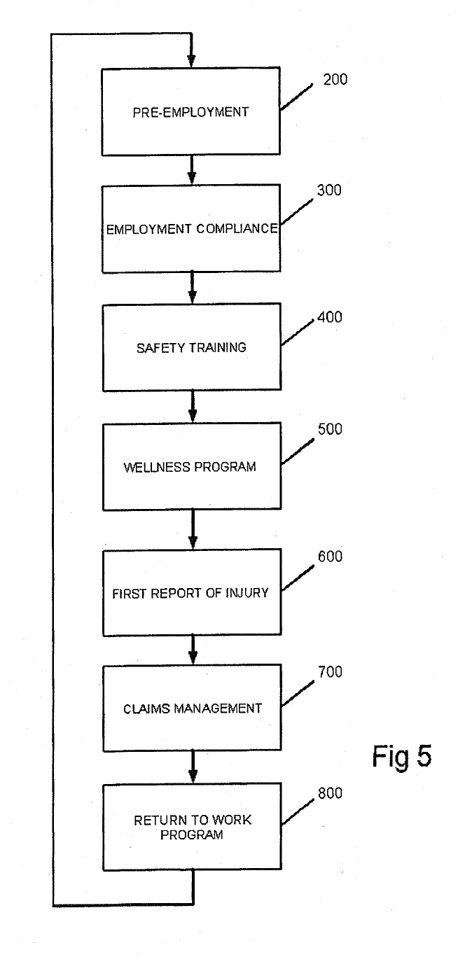

Referring now to FIG. 5, this diagram illustrates a typical occupational health employee life cycle. A pre-employment phase 200 relates to a prospective employee. In this phase, data about the prospective employee's ability to do a job and whether the results of their pre-employment occupational health tests comply with minimum standards set by industrial regulations is collected and analysed. If the prospective employee has been employed by a client of the system before, they will have historic occupational health data as well as an employment history already in the database. This is their employment life cycle record. This therefore provides the employer with much more occupational health related parameters about the prospective employee to assist in an employment decision.

During employment of an employee employment compliance data is collected from employee throughout the term of their employment (an employment compliance phase 300). Data is gathered from ongoing occupational health tests during the term of employment to determine that employees' occupational health continually meets standards set by regulatory bodies or by the corporation employing them and that they are fit to do the job for which they are employed. Also insurance company requirements can be adhered to. For example regular or spot tests such a drugs test can be performed where blood and/or urine samples are tested and the results are stored in the database together with the analysis by an examiner on whether they comply with the requirements of the insurer, the company or the regulatory body.

Employees are given safety training 400 on equipment throughout their terms of employment and data can be collected to ensure that employees are given safety training programs at the regular time intervals prescribed by regulatory bodies and also that their safety training is up to date. Data such as times and dates of any safety programs attended and details of the safety program can be collected and stored in the database.

Wellness programs 500 are programs run by an employer or given by an occupational health consultant on behalf of an employer that employees attend during the course of their employment. These can be fitness programs, RSI programs, cancer awareness programs, anti-obesity programs or anti-smoking programs, for example. Data can be entered regarding details of wellness programs attended by employees so employers can ensure that the general health of their employees allows them to do the jobs they are employed for. Details of wellness programs run by clients for their employees and fitness monitoring of the clients' employees can be input to the occupational health data system. For example, insurance companies may offer clients lower insurance premiums if their employees attend programs to help them give up smoking. Insurance companies can also access data about the wellness programs run by clients from the occupational health data system.

A first report of injury program 600 requires the reporting of the scene of an accident in the workplace where an employee has been injured and the accident circumstances. The reporting also includes reports of ‘near misses’. This data is entered into the database by the employer when an injury or near miss occurs and includes the employee, other people involved, the person causing the accident or injury, the location, the time, witness statements, the equipment involved etc. The data can comprise text, audio, pictures or video and can include pictures of the scene, a video witness statement etc. For example, it is possible for the foreman of a site to have mobile apparatus to photograph the scene of an accident and dictate an accident report or first report of injury, which can then be transmitted to the client using the means for communication provided in the occupational health data system. These reports must be passed to relevant regulatory bodies of health and safety in the workplace and to the insurance company of the employer concerned.

Claims management 700 is the way in which an employer and their insurance company deal with the claims for damages made by an employee who has been injured as a result of an accident in the workplace. This program includes giving the employee regular medical checks and assessing the results to determine whether they are fit for work or if the insurance company is required to carry on paying a salary.

A return to work program 800 provides for the assessment of an employee who has been injured as a result of an accident in the workplace to determine if they are fit to go back to working in the same role as before injury or, if not, which job are they now qualified for to meet minimum regulatory body or corporate standards. If the employee is not fit to return to their original job type, the data will include a specification of the job type that they are fit to carry out. The employee can thus be returned to the pre-employment phase of the employee life cycle again with a new job type assigned to them.

The above programs are the more generic programs implemented in the employee life cycle management system. The system can also perform more specific programs.

The employee life cycle management system performs data management; that is recording occupational health data, processing data and managing data. This includes generating reports relating to occupational health and analysing trends in data, for example comparing the results of audiometric tests to the length of service of an employee. These reports can be tailored by clients of the system to meet their reporting needs.

The employee life cycle management system can also provide a substance abuse program for employee. This can comprise a process whereby employees are required to undergo regular testing. The management of the testing program and the results is provided by the system to ensure corporate or regulatory compliance.

The employee life cycle management system can also provide audiometric management. This is particularly important where employees are subjected to a noisy working environment. Regular audiometric testing and management of the results provides the employer with a record of the employee's auditory function and enables the monitoring of any changes.

The employee life cycle management system provides for trend analysis, legal compliance monitoring, employee liability risk analysis and monitoring as well as health and safety analysis and monitoring.

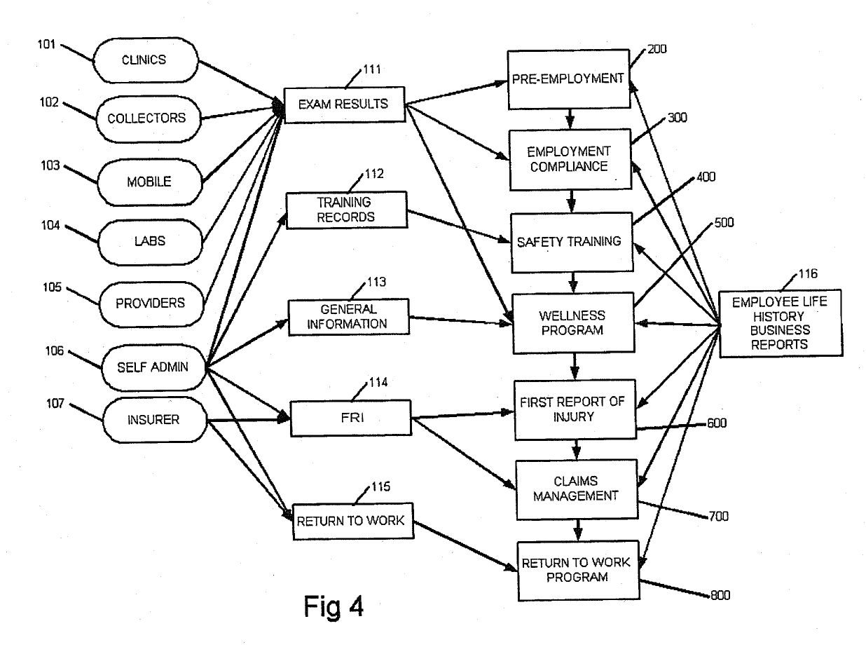

FIG. 4 illustrates the concept of the employee life cycle management system. On the left sources of data are shown inputting the data. The data is then used during the managed process illustrated in FIG. 5. Clinics 101, collectors 102, mobile facilities, 103, laboratories 104, providers 105, and self-administration by employers 106 provide examination data 111 in the database. An employer performing self-administration 106 also inputs training data 112, injury reports 114 and return to work data 115. An insurer 107 will input data specifying requirement for injury reports 114 and return to work programs 115. The examination data 111 is used in the pre-employment program 200, the employment compliance program 300, the wellness program 500. The training data 112 is used in the safety training program 400. General information is also provided and this is used in the wellness program 500. The injury data 114 is used in the first report of injury program 600 and the claims management program 700. The return to work data 115 is used in the return to work program 800.

The employee life cycle management system provides for employee life cycle reports 116 which can be tailored as required by the client (employer).

The system also provides for industry wide reports. These reports at an industry level can be generated periodically e.g. annually for all employees and employers in an industry. For example, a report can be generated for a demographically division of employees in an industry showing 25 dB shift in their audiometric response, or a report can identify which illegal or banned substance were found most regularly in blood or urine tests taken for employees within an industry. Such data can be further subdivided into job types, age, sex, geographical location etc. These reports can assist the industry and employers to devise effective occupational health programs.

The system can further allow any entity that contributes data to the database access to the data and to reports that may be definable by the entity.

Since the system is a network of contributors to the occupational health database, it can be used to facilitate communications between the entities. The system allows contributors including any client or entity involved in the management or provision of the data to send and receive occupational health related communications e.g email. The system can thus provide for example an email forwarding/composing service to allow entities to send each other email. Such technology is well known in the art. Thus the system provides a community all concerned with the provision, processing, review/examination, regulation, or use of occupational health data that can communicate freely and easily. The system can allow for the division of the community into groups and for inter group communications.

In one embodiment of the present invention, employees have a biometric, such as a fingerprint, retinal scan, hand shape or DNA, taken at the commencement of their employment to enable the unique identification of the employee. The biometric measurement is stored in the database with the employee's record. Thus when an employee presents themselves for an occupational health test e.g. a blood test, a urine test, an eye test, a medical check up an X ray or an audiometric test, a biometric measurement of the employee can be taken and this can be compared with the stored biometric to check whether the person presenting themselves for the test is indeed the employee. The comparison of the measure biometric with the stored biometric can take place immediately the employee presents themselves if there is access to the central database available i.e. there is a means of communicating with the life cycle management system. This enables the immediate security checking of the testing. Alternatively, if there is no means of communicating with the central database, e.g. the testing is being performed using a mobile facility that is visiting a remote employer site, the biometric measurement can be stored with the test data for the later processing of the data to check the identity of the tested person when access to the central database is available.

This ensures that there is a chain of evidence leading back to the test so it is possible to prove that a certain employee took a test at a particular time and place. The use of the biometric can also be extended to identify the tester who performed the test. This adds a further level of security for the validation of the test result.

In this way, a situation can be avoided whereby, say, an employee taking and passing an audiometric test and subsequently claiming damages from his employer for loss of hearing could claim that someone else took the test for him or the test was not validly taken for some reason. With the current system of occupational health data flow there is no way of preventing this from happening.

In one embodiment the test facility can comprise a mobile unit equipped to go to company sites and perform various occupational health tests. This is particularly useful for companies in remote locations and provides a quicker, more efficient way of performing occupational health tests on employees, rather than sending them many miles away to a clinic in the nearest town. In this way, the clinic actually comes to the company and the mobile unit replaces the provider, OH vendor or clinic.

The mobile unit is equipped to perform a wide range of occupational health tests, for example audiometric tests, substance abuse tests, blood tests or other physical examinations such as X-rays or EKGs. Data collected from tests and examinations performed on the mobile unit is uploaded onto a mobile database. This database is a mirror image of the central database so test results can be accessed by any of the members of the occupational health data system. However, the database has the added feature that functionalities can be switched on and off as required, depending on the tests that are to be performed. For example, if the mobile unit is only performing audiometric tests at a particular time, the functionality for substance abuse tests and other physical examinations can be switched off, thus saving space on the mobile database. When the mobile unit is able to access the central database, the recorded data can be uploaded to the central database and the central and local databases can thus be resynchronised (mirrored).

In the occupational health data system, data can be recorded in any medium that can be communicated over a network and recorded on a database, such as written information, recorded sound, photographs or video footage. Occupational health suppliers or providers are connected to each other and to their clients (employers) by a means for communication, which can be the internet, telephone or mail, or a combination of any of these communication means. This provides a network between occupational health providers and their clients.

Thus the present invention provides the advantage of a complete occupational health data system that has the ability to manage all employee life cycle data. In addition, the present invention provides the advantage that occupational health data, such as test results, is immediately available to clients. The present invention can also provide the advantage of a secure system for managing occupational life cycle data, whereby occupational health tests and test results can be traced to the employee to which they are associated. The present invention can also provide the advantage of a mobile occupational health data management system that can be brought to the workplace.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A secure occupational health management method, the method comprising:
storing employee related data in a database;
associating unique biometric identifier data for employees with the employee related data in the database;
receiving occupational health data collected from the employee accompanied with measured biometric identifier data obtained from the employee during the collection of the occupational health data from the employee;
comparing the measured biometric identifier data with the unique biometric identifier data stored in the database; and
storing the collected occupational health data from the employee in the database if the comparison indicates a match of the measured biometric identifier data with the stored biometric identifier data.

2. The method according to claim 1, including collecting said occupational health data from said employee using a mobile occupational health data collection facility.

3. The method according to claim 1, wherein said occupational health data comprises test data obtained from a test of a physical or mental function of said employees.

4. The method according to claim 1, including processing the occupational health data to generate employee life cycle data, and storing the employee life cycle data in the database.

5. The method according to claim 1, including providing the occupational health data to at least one reviewer or examiner to review or examine the occupational health data, receiving reviewer data or examiner data from said at least one reviewer or examiner, and storing the received reviewer or examiner data in the database.

6. A secure occupational health management system, the system comprising:
a database storing employee related data and associated unique biometric identifier data for employees;
an interface for receiving occupational health data collected from the employee accompanied with measured biometric identifier data obtained from the employee during the collection of the occupational health data from the employee; and
a processor for comparing the measured biometric identifier data with the unique biometric identifier data stored in the database, and for storing the collected occupational health data from the employee if the comparison indicates a match of the measured biometric identifier data with the stored biometric identifier data.

7. The system according to claim 6, including a mobile occupational health data collection facility for collecting said occupational health data from said employee.

8. The system according to claim 6, wherein said occupational health data comprises test data obtained from a test of a physical or mental function of said employees.

9. The system according to claim 6, wherein said processor is adapted to process the occupational health data to generate employee life cycle data, and to store the employee life cycle data in the database.

10. The system according to claim 6, including at least one interface to allow the occupational health data to be reviewed or examined by at least one reviewer or examiner, to receive reviewer data or examiner data from said at least one reviewer or examiner, and to storing the received reviewer or examiner data in the database.
